(19) United States
(12) Patent Application Publication
(10) Pub. No.: US 2007/0062170 A1
(43) Pub. Date: Mar. 22, 2007

(54) Lawn mower and cutting deck height adjustment pin for use with same

(76) Inventor: Steven C. Finkner, Adams, NE (US)

Correspondence Address: MUETING, RAASCH & GEBHARDT, P.A., P.O. BOX 581415, MINNEAPOLIS, MN, 55458, US

(21) Appl. No.: 11/232,198

(22) Filed: Sep. 21, 2005

(51) Int. Cl. A01D 34/00

(52) U.S. Cl. 56/14.9

(57) ABSTRACT

A cutting deck height adjustment system utilizing cutting height adjustment pins. The pins include two or more first holes that each define an axis that is parallel to the other. At least one third hole may be located longitudinally between the two or more first holes. The third hole defines an axis that is skewed relative to the axes of the two or more first holes. The axes of each of the first, second, and third holes may, in one embodiment, be normal to a longitudinal axis of the adjustment pin. By skewing the third hole, adjacent holes may be located in close proximity to one another while maintaining adequate structural integrity of the pin when a hairpin is inserted into one of the holes.

### TECHNICAL FIELD

The present invention relates generally to lawn mowers and, more particularly, to a pin for adjustably interconnecting a lawn mower cutting deck to a support frame.

### BACKGROUND

Riding, rotary lawn mowers have been in use for years. Conventional riding mowers may utilize rear driving wheels and steerable front wheels. A cutting deck, operable to mow lawns and the like, is typically located between the front and rear wheels. While effective, conventional riding mowers have limited maneuverability, mostly attributable to their relatively large turning radius. As a result, these mowers are perceived by landscape professionals as being less efficient than, for example, wide-area walk-behind mowers.

In recent years, ride-on, zero-radius-turning (ZRT) mowers have gained in popularity due to their improved maneuverability and accompanying potential increases in mowing efficiency. These mowers are often configured with either a “mid-mount” cutting deck, where the deck is generally mounted between front and rear wheels, or with an “out-front” deck, wherein the deck is coupled to a support frame extending forwardly from the mower. Out-front ZRT mowers offer exceptional versatility due not only to their high maneuverability, but also because of the forward position of the deck, which permits mowing in places that are not easily accessible with other types of riding mowers. Out-front mower decks may also offer improved serviceability as the support frame can typically be pivoted relative to the mower, thereby exposing the underside of the deck for maintenance tasks, e.g., blade removal.

While advantageous, out-front mowers do have drawbacks. For example, many out-front decks are suspended from the support frame by fasteners or vertical adjustment pins. In the case of the latter, the cutting deck is typically lowered (or raised) by moving hairpins between a series of aligned, parallel holes spaced along the length of each adjustment pin, effectively raising (or lowering) the deck relative to the ground.

To accommodate the desired hairpin size without sacrificing the integrity of the adjustable pin (e.g., to maintain sufficient structural integrity of the adjustable pin between adjacent holes), the holes are typically spaced at increments of about 0.5 inches or more. Some mowers (e.g., trim mowers), however, benefit from a finer height of cut adjustment increment. To achieve incremental spacing, a spacer is typically provided. The spacer may be optionally placed between the hairpin and the top of the support frame to allow selection of heights of cut that are between those provided by the hairpin holes. That is, when a height of cut between that provided by adjacent holes in the adjustment pin is desired, the hairpin may be removed, the spacer placed onto the adjustment pin, and the hairpin reinserted. This effectively raises the deck an increment (e.g., 0.25 inches) less than the hole spacing. When not needed, the spacer may be removed and placed over the top of the adjustment pin where it may rest upon the hairpin.

While effective, the spacer is prone to loss and/or misplacement. Moreover, the spacer requires the additional step of placement/removal during the deck height adjustment process.

### SUMMARY

Embodiments of the present invention may overcome these and other issues associated with prior art mowers by providing a cutting height adjustment pin and mower incorporating the same. In one embodiment, a lawn mower is provided having a support frame; a cutting deck; and a cutting height adjustment pin. The pin has a first end to extend upwardly through the support frame, and a second end to couple to the cutting deck. A portion of the pin proximate the first end defines both a first through hole and a longitudinally offset second through hole, the second through hole defining an axis that is nonparallel to an axis of the first through hole, and wherein the axes of each of the first through hole and the second through hole are normal to a longitudinal axis of the pin.

In another embodiment, a lawn mower is provided having a support frame; a cutting deck; and a cutting height adjustment pin for adjustably connecting the cutting deck to the support frame. The pin has a longitudinal axis that is normal to, and intersected by: a first through hole; a second through hole longitudinally offset and parallel to the first through hole; and a third through hole located intermediate the first through hole and the second through hole. An axis of the first through hole and the longitudinal axis form a first plane, and an axis of the third through hole and the longitudinal axis form a second plane that intersects the first plane at an angle of about 30 to about 60 degrees.

In yet another embodiment, a lawn mower is provided having a support frame; a cutting deck; and a cutting height adjustment pin for adjustably connecting the cutting deck to the support frame. The pin defines a longitudinal axis, the longitudinal axis being normal to, and intersected by: a plurality of first through holes each longitudinally offset from one another; and a plurality of second through holes each longitudinally offset from one another such that one second hole of the plurality of second through holes is located between consecutive first holes of the plurality of first through holes. Further, axes of each of the plurality of first through holes are contained within a first plane, and axes of each of the plurality of second through holes are contained within a second plane, the first plane intersecting the second plane at an angle of about 30 to about 60 degrees.

The above summary is not intended to describe each embodiment or every implementation of the present invention. Rather, a more complete understanding of the invention will become apparent and appreciated by reference to the following Detailed Description of Exemplary Embodiments and claims in view of the accompanying figures of the drawing.

### BRIEF DESCRIPTION OF THE VIEWS OF THE DRAWING

The present invention will be further described with reference to the figures of the drawing, wherein:

FIG. 1 is a perspective view of a vehicle, e.g., lawn mower, incorporating an exemplary cutting deck height adjustment system, the system including a cutting deck and cutting height adjustment pin in accordance with one embodiment of the present invention;

FIG. 2 is a side elevation view of the deck height adjustment system of FIG. 1 illustrating the deck at a first height (solid lines) and a second height (broken lines), wherein a portion of the system is shown in section;

FIG. 3 is a partial exploded view of the system of FIG. 1 showing two of the cutting height adjustment pins;

FIG. 4 is a side elevation view of a cutting height adjustment pin in accordance with one embodiment of the invention;

FIG. 5 is a side elevation view of a cutting height adjustment pin in accordance with another embodiment of the invention; and

FIG. 6 is a section view taken along lines 6-6 of both FIGS. 4 and 5.

Unless stated otherwise herein, the figures of the drawing are rendered primarily for clarity and thus may not be drawn to scale. Moreover, in some figures, certain structure may be removed to improve clarity.

### DETAILED DESCRIPTION OF EXEMPLARY EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the invention.

Generally speaking, the present invention is directed to a lawn mower incorporating a cutting deck height adjustment system having one or more cutting height adjustment pins. The pins permit fine adjustment of the cutting deck height without the use of extraneous hardware such as removable spacers.

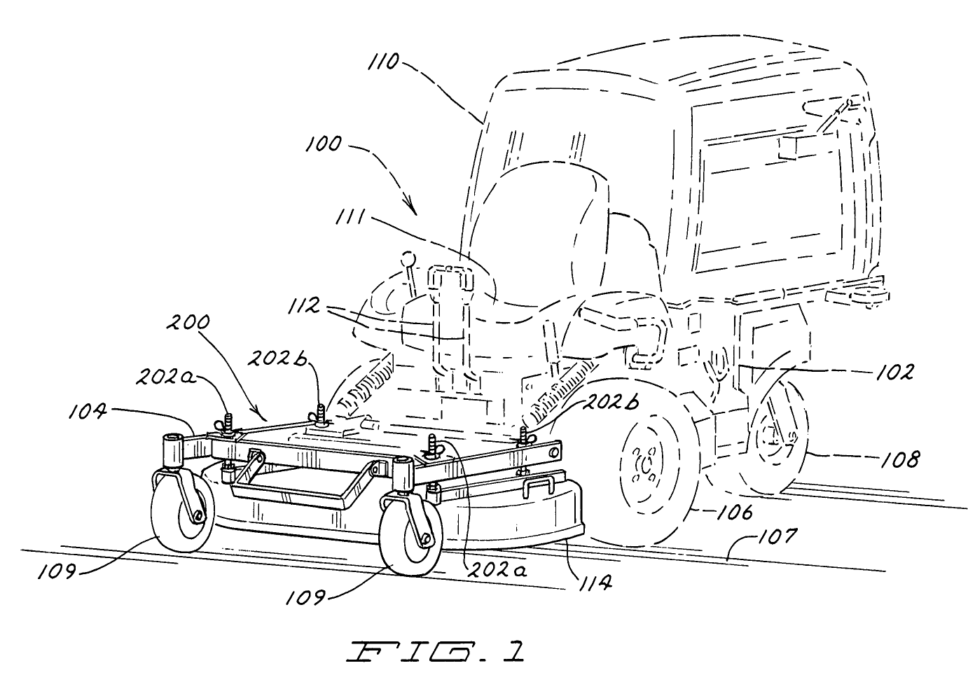

FIG. 1 illustrates a cutting deck height adjustment system 200 in accordance with one embodiment of the present invention as it may be incorporated on a vehicle, e.g., a ZRT power lawn mower 100. While described with respect to cutting height adjustment on a particular power lawn mower (hereinafter generically referred to as a “mower”), those of skill in the art will realize that the invention is equally applicable to other types of riding or walk-behind mowers, as well as to most any other working vehicle wherein fine height adjustment of an implement is desired.

FIG. 1 illustrates the exemplary mower 100 (shown primarily in broken lines) having underlying structure (a mower frame 102) that supports a prime mover, e.g., internal combustion engine (not shown). A pair of transversely opposing, ground engaging drive wheels 106 (only left wheel visible in FIG. 1) may support the mower 100 in rolling engagement with a ground surface 107. A castoring (or steerable) trailing rear wheel 108 may support a rear portion of the mower in a tricycle-type configuration. Each drive wheel 106 may be powered by a hydraulic motor (not shown) which receives power from a hydraulic pump under the control of an operator. The hydraulic pumps, in turn, may be powered by the engine. Other wheel drive systems (e.g., mechanical systems) are also possible without departing from the scope of the invention.

An implement, e.g., cutting deck 114, may be attached generally forward of the drive wheels 106, yielding an out-front mower configuration. The implement may include a frame (e.g., a support frame 104) that attaches to the mower and supports the deck 114 during operation. The cutting deck 114 may also include one or more cutting blades (not shown) as is known in the art. During operation, power is selectively delivered to the blades of the cutting deck 114 by the engine, whereby the blades rotate at a speed sufficient to sever grass and other vegetation over which the deck passes. A pair of front caster wheels 109, which connect to forwardly extending portions of the support frame 104, may support the cutting deck in rolling engagement with the ground surface 107.

An optional grass catcher 110 may also be provided to collect grass clippings. Typically, a powered blower (not shown) is provided to transport the clippings from a rear or side discharge port on the cutting deck 114 to the catcher 110.

The mower 100 may be controlled by the operator, sitting in an operator seat 111, via manipulation of various controls (e.g., drive control levers 112) as is known in the art.

As used herein, relative terms such as “left,” “right,” “fore,” “forward,” “aft,” “rearward,” “top,” “bottom,” “upper,” “lower,” “horizontal,” “vertical,” and the like are, if used, from the perspective of one operating the mower 100 while the mower is in an operating configuration, e.g., while the mower 100 is positioned such that the wheels 106, 108, and 109 rest upon the generally horizontal ground surface 107 as shown in FIG. 1. These terms are used herein only to simplify the description, however, and not to limit the scope of the invention in any way.

The reference numeral suffixes “a” and “b” may be used throughout this description to denote variations of otherwise substantially similar parts or part features. Unless otherwise noted, the description of an individual part/feature (e.g., the description of a part/feature identified with an “a” suffix) may also apply to the corresponding part/feature (e.g., the part/feature identified with a “b” suffix). Similarly, unless otherwise noted, the description of a part/feature identified with no suffix may apply to both the part/feature identified with the “a” suffix and the “b” suffix.

It is further noted that the terms “comprises” and variations thereof do not have a limiting meaning where these terms appear in the accompanying description and claims. Moreover, “a,” “an,” “the,” “at least one,” and “one or more” are used interchangeably herein.

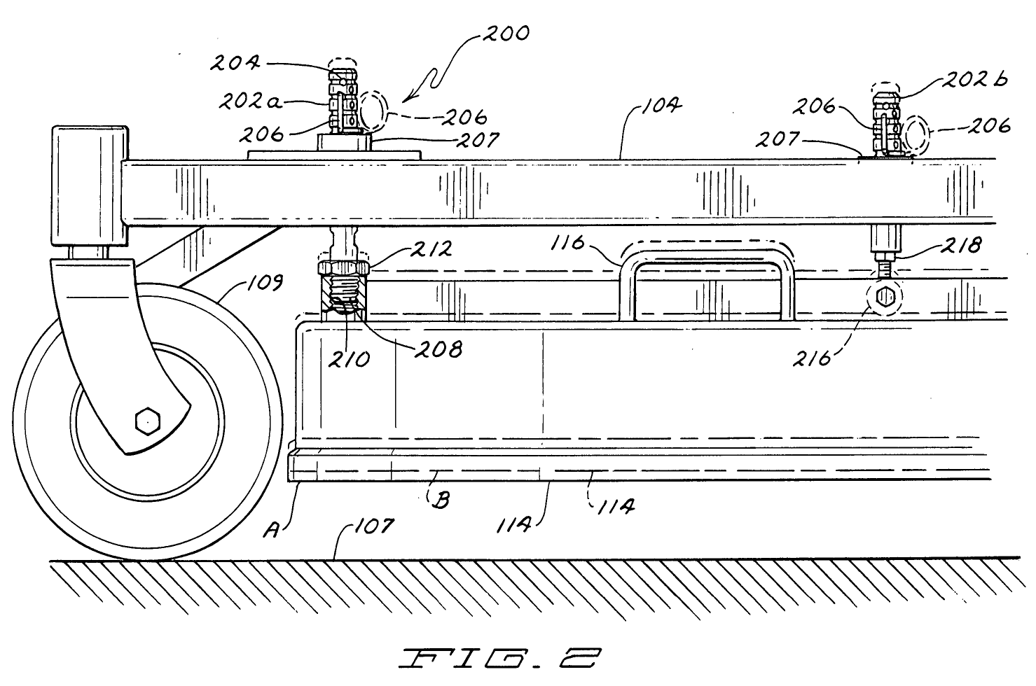

FIG. 2 is an enlarged side elevation view of the deck height adjustment system 200. The system is shown positioning the deck 114 in both a first cutting height (position “A”) and a second cutting height (position “B” in broken lines). As illustrated in this view, the system may include cutting height adjustment pins 202 (e.g., pins 202a and 202b) that couple to both the cutting deck 114 and the support frame 104, e.g. pass through openings in the support frame.

The pins 202 may each include at least a first through hole 204 and a longitudinally offset (along the length of the pin) second through hole. The holes may define axes that are nonparallel to one another and that are normal to a longitudinal axis of the pin as further described below. In the illustrated embodiments, each pin 202 includes an array of cross-drilled through holes 204 located near their respective first or upper ends. The holes 204 are operable to receive a fastener, e.g., a hairpin 206. By relocating the hairpins 206 to the appropriate hole 204, the pins 202 may be effectively raised or lowered, thus moving the cutting deck 114, relative to the frame 104, among positions A, B, or others. A washer 207 may optionally be provided underneath each hairpin 206 to support the same. The washer 207 is intended to remain in place regardless of the desired cutting deck height. In other words, the washer 207 is not manipulated to change the cutting deck height (the rear washer 207 is shown upon a recessed portion of the support frame 104. As a result, only a top portion is visible in FIG. 2).

In the illustrated embodiment, the pins 202 are of a slightly different configuration depending on their particular location, e.g., near the forward portion of the deck 114 or near the rearward portion. For example, the illustrated embodiment utilizes two pins 202a, which support the forward portion of the cutting deck 114. Each pin 202a has a lower or second end incorporating a male threaded portion 208 that is received in a threaded opening 210 as shown in section in FIG. 2. A jam nut 212 may be provided to secure the pin 202a within the opening 210.

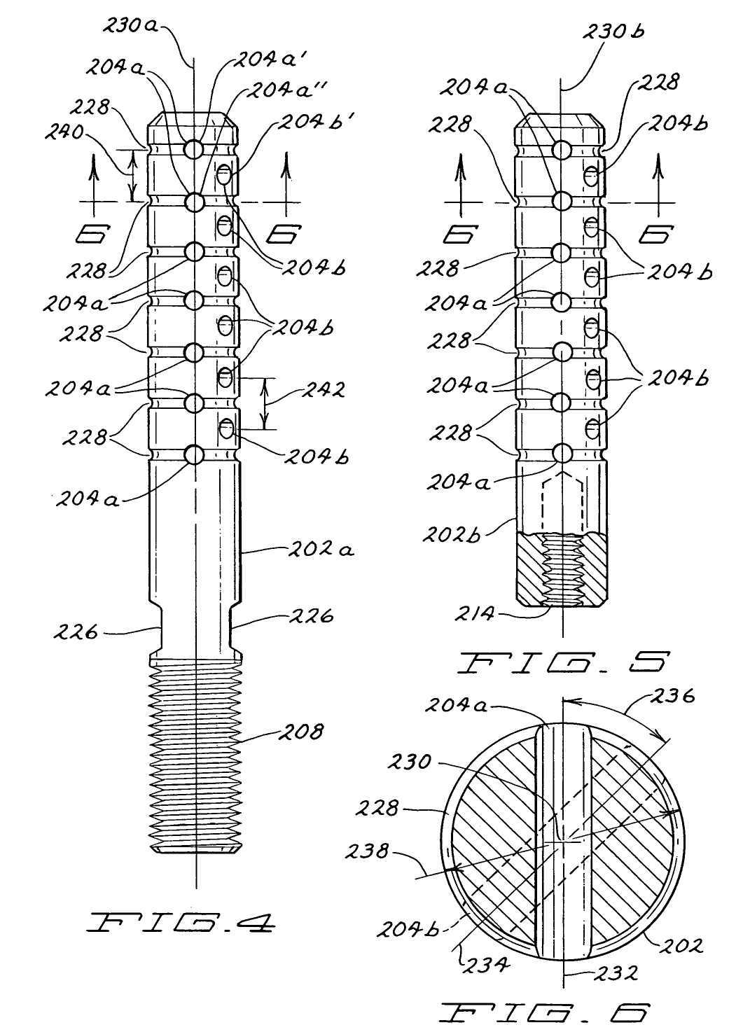

Similarly, the system 200 may include two pins 202b that are used to support the aft or rearward portion of the deck 114. Each pin 202b is similar in most respects to the pin 202a with the exception that each may include a female threaded portion 214 (see FIG. 5) at its second end. The female threaded portion 214 is operable to receive a male thread of a spherical rod end or balljoint 216. A jam nut 218 may be provided to secure the pin 202b relative to the balljoint 216.

FIG. 3 is an exploded view of part, e.g., the right side, of the adjustment system 200. The left side is generally a mirror image of what is illustrated in FIG. 3. Once again, this view illustrates the pins, e.g., pins 202a and 202b, along with their accompanying washers 207 and hairpins 206. As described above, the front adjustment pin 202a may include the male threaded portion 208 (to engage the threaded opening 210) and the jam nut 212. The balljoint 216 is also shown exploded from the rear adjustment pin 202b. Fasteners, e.g., bolt 220 and nut 222, may be provided to secure the balljoint 216 to an attachment point (e.g., opening 223) located on structure 221 of the deck 114. A spacer 224 may be provided to offset the pin 202b outboard from the attachment point.

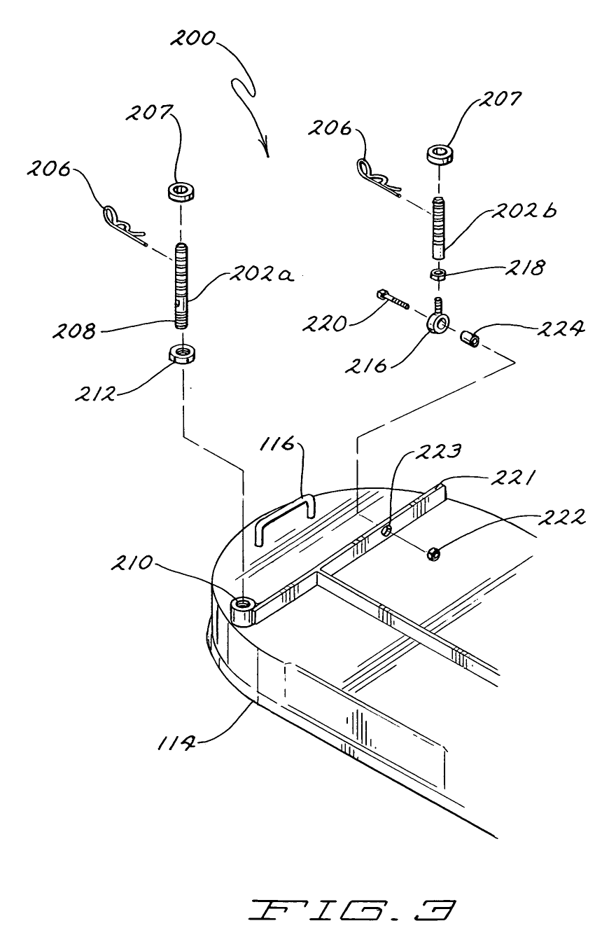

FIG. 4 is an enlarged side elevation view of the front adjustment pin 202a. As described above, a first or upper end of the pin 202a may include: a first through hole (e.g., hole 204a′); and a second through hole (e.g., hole 204a″) longitudinally offset from, and parallel to, the first through hole 204a′. A third through hole (e.g., hole 204b′) may be located intermediate the first through hole 204a′ and the second through hole 204a″. While a pin incorporating only three holes (e.g., holes 204a′, 204a″, and 204b′) is contemplated, each pin 202 preferably includes a series of first holes 204a and a series of second holes 204b, wherein one of the series of second holes is located between each pair of consecutive first holes.

A visual indicator, e.g., circumferential groove 228, may be provided on an outer cylindrical surface of the pins 202a and 202b. In the illustrated embodiment, the grooves 228 are located to correspond to each of the first holes 204a, e.g., each of the first holes 204a may be intersected by one groove 228. However, other locations, and other visual indicators, are certainly possible without departing from the scope of the invention.

A second or lower end of the pin 202a includes the male threaded portion 208 as already described herein. Wrench flats 226 may also be provided to permit tightening against the jam nut 212 (see FIGS. 2 and 3) during installation.

Each hole 204a of the series of first holes may define a hole axis 232 (see FIG. 6) that is coplanar and parallel with the axes of the other holes 204a. Moreover, each axis of each of the first holes 204a may intersect with, and is preferably normal to, a longitudinal axis 230 (axis 230a or 230b) of the respective pin 202 (pin 202a or 202b). Similarly, each second hole 204b of the series of second holes may define an axis 234 (see FIG. 6) that is coplanar and parallel with the axes of the other second holes 204b. Further, each axis of each of the second holes 204b may also intersect with, and is preferably normal to, the longitudinal axis 230.

FIG. 5 is an enlarged side elevation view of the rear adjustment pin 202b. The pin 202b includes a first or upper end that is substantially identical to the first end of the pin 202a. A second or lower end of the pin 202b, however, is configured to accommodate the balljoint 216 (see FIGS. 2 and 3) as already described herein. The pin 202b may be shorter to accommodate the length of the balljoint 216.

While two embodiments of the adjustment pin are illustrated herein (e.g., 202a and 202b), those of skill in the art will realize that other adjustment systems could utilize the same pin for all connection points. Moreover, while illustrated with four pins, other configurations could utilize more or less pins without departing from the scope of the invention.

FIG. 6 illustrates a common cross section taken along lines 6-6 of both FIGS. 4 and 5. In this view, one of the first holes 204a is visible, while one of the second holes 204b, which is longitudinally offset from the identified first hole, is shown in broken lines. As described above, the first axis 232 and the second axis 234 are normal to, and preferably intersect, the longitudinal axis 230. However, the first axis 232 and the second axis 234 are nonparallel, e.g., skewed, relative to one another. That is, a first plane formed by the combination of the first axis 232 and the longitudinal axis 230 forms an angle 236 of about 20 to about 90 degrees, preferably about 30 to about 60 degrees, and more preferably, about 45 degrees, with a second plane formed by the combination of the second axis 234 and the longitudinal axis. Once again, the axes 232 of all first holes 204a are preferably parallel to each other, as are the axes 234 of all the second holes 204b.

While not wishing to be limited to any particular configuration, the pins 202 may have an outer diameter 238 of about 0.75 to about 1 inch, e.g., about 0.88 inches. Each of the through holes 204a and 204b may be about 0.18 to about 0.2 inches, e.g., about 0.19 inches, in diameter to accommodate a hairpin 206 having a body diameter of, for example, about 0.18 inches. A distance 240 (see FIG. 4) of about 0.5 inches may be provided between axes of each of the first holes 204a (and thus between the adjacent grooves 228). A distance 242, also about 0.5 inches, may be provided between axes of adjacent second holes 204b, each of which are preferably centered between pairs of consecutive first holes 204a. As a result, a hole 204 may be located about every 0.25 inches along the upper portion of the each pin 202a and 202b. In other embodiments, the holes may be located at most any spacing. In fact, adjacent holes may be positioned in such close proximity that they may even break through one another as long as sufficient pin material remains to provide adequate structural integrity to the pin under normal operation conditions. Thus, for any given embodiment of the pins 202, the actual spacing between holes may be selected based upon pin 202 and hole 204 sizes, as well as upon intended pin loading.

In operation, the cutting deck may be moved (e.g., raised) between the A position and the B position of FIG. 2 (or to any other position) as described below. First, the operator may stop the cutting deck 114 and mower engine, and preferably apply the parking brake. While standing on a first, e.g., left side, of the mower, the operator may grasp the cutting deck 114, e.g., via the nearest lift handle 116, to lift the same. The hairpins 206 may then be removed from the left front adjustment pin 202a and the left rear adjustment pin 202b. The left side of the deck 114 may then be lifted by the operator until the through hole 204 corresponding to the B position is visible above the washers 207. The grooves 228 may be used to assist the operator in identifying the desired locations on the pins 202a and 202b. The hairpins 206 may then be inserted through the desired holes, and the deck lift handle released until the deck rests again upon the hairpins. The same procedure may be performed to the right side of the deck 114.

The engagement of the pin 202a with the threaded opening 210 (see FIG. 2) and the engagement of the balljoint 216 with the female threaded portion 214 (see FIG. 5) may be set to ensure that the cutting deck 114 maintains the desired front-to-rear slope. For example, in one embodiment, the pins 202 are so threaded to ensure that the front of the deck 114 is slightly lower, e.g., about 0.25 inches, than the rear of the deck for any given height of cut.

Adjustment pins 202 in accordance with embodiments of the present invention are thus able to provide fine height adjustment of the cutting deck 114 relative to the mower support frame 104 without the use of extraneous spacers. By clocking the series of second holes 204b relative to the series of first holes 204a on the height adjustment pins 202, adjacent holes may be located in close proximity to one another while maintaining adequate structural integrity to support the cutting deck.

Illustrative embodiments of this invention are discussed and reference has been made to possible variations within the scope of this invention. These and other variations, combinations, and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

What is claimed is:

1. A lawn mower comprising:
a support frame;
a cutting deck; and
a cutting height adjustment pin comprising a first end to extend upwardly through the support frame, and a second end to couple to the cutting deck, wherein a portion of the pin proximate the first end defines both a first through hole and a longitudinally offset second through hole, the second through hole defining an axis that is nonparallel to an axis of the first through hole, and wherein the axes of each of the first through hole and the second through hole are normal to a longitudinal axis of the pin.

2. The mower of claim 1, wherein the second end of the pin comprises a threaded portion.

3. The mower of claim 1, wherein a first plane formed by the axis of the first through hole and the longitudinal axis of the pin forms an angle of about 20 to about 90 degrees with a second plane formed by the axis of the second through hole and the longitudinal axis.

4. The mower of claim 3, wherein the angle is about 45 degrees.

5. A lawn mower comprising:
a support frame;
a cutting deck; and
a cutting height adjustment pin for adjustably connecting the cutting deck to the support frame, wherein the pin has a longitudinal axis that is normal to, and intersected by: a first through hole; a second through hole longitudinally offset and parallel to the first through hole; and a third through hole located intermediate the first through hole and the second through hole;
wherein an axis of the first through hole and the longitudinal axis form a first plane, and an axis of the third through hole and the longitudinal axis form a second plane that intersects the first plane at an angle of about 30 to about 60 degrees.

6. The mower of claim 5, wherein the angle is about 45 degrees.

7. The mower of claim 5, wherein the pin comprises an outer cylindrical surface defining one or more circumferential grooves formed therein.

8. The mower of claim 7, wherein the cylindrical surface defines a first groove that intersects the first through hole, and a second groove that intersects the second through hole.

9. The mower of claim 5, wherein a distance between the axis of the first through hole and an axis of the second through hole is about 0.5 inches.

10. The mower of claim 9, wherein a distance between the axis of the first through hole and the axis of the third through hole is about 0.25 inches.

11. The mower of claim 5, wherein the pin comprises a threaded portion for engaging the cutting deck.

12. A lawn mower comprising:
a support frame;
a cutting deck; and
a cutting height adjustment pin for adjustably connecting the cutting deck to the support frame, wherein the pin defines a longitudinal axis, the longitudinal axis being normal to, and intersected by: a plurality of first through holes each longitudinally offset from one another; and a plurality of second through holes each longitudinally offset from one another such that one second hole of the plurality of second through holes is located between consecutive first holes of the plurality of first through holes;
wherein axes of each of the plurality of first through holes are contained within a first plane, and axes of each of the plurality of second through holes are contained within a second plane, the first plane intersecting the second plane at an angle of about 30 to about 60 degrees.

13. The mower of claim 12, wherein the angle is about 45 degrees.

14. The mower of claim 12, wherein the plurality of first through holes and the plurality of second through holes are located proximate a first end of the pin.

15. The mower of claim 14, wherein a second end of the pin comprises a threaded portion.

16. The mower of claim 15, wherein the threaded portion comprises a male thread.

17. The mower of claim 15, wherein the threaded portion comprises a female thread.

18. The mower of claim 12, wherein a distance between axes of consecutive first holes of the plurality of first through holes is about 0.5 inches.

19. The mower of claim 18, wherein a distance between an axis of a first hole of the plurality of first through holes and an axis of an adjacent second hole of the plurality of second through holes is about 0.25 inches.

20. The mower of claim 12, wherein the pin further comprises an outer cylindrical surface defining circumferential grooves that intersect one or more of the plurality of first through holes.
